(19) United States
(12) Patent Application Publication
(10) Pub. No.: US 2004/0106882 A1
(43) Pub. Date: Jun. 3, 2004

(54) Kneading massage structure

(76) Inventor: Chin-Chun Tseng, Chung-Ho City (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 10/306,219

(22) Filed: Nov. 29, 2002

(51) Int. Cl. A61H 7/00

(52) U.S. Cl. 601/86; 601/87; 601/100; 601/103

(57) ABSTRACT

It is a kind of kneading applied massage structure containing a base and a massage device. On the inner wall of one side of the base is bound with a sliding rail in which is bound a slide plate. A screw bolt is connected in the base, and the both two ends of the screw bolt are positioned in the pillow block for ball bearing, which connects one end of the screw bolt to the power-take-off shaft of one motor. On the screw bolt is bound with a slide plate with a positioning plate on it. The said massage device includes a tapered massage block which may rotate on request from inner to outer or from outer to inner; to position the massage device on the slide plate and positioning plate; when the motor runs, it will drive the screw bolt to rotate, which makes the slide block on the screw bolt move up or down, and the massage device will also move with the rotation. Thus, the users will enjoy the kneading massage up or down or at a fixed position on the back to relieve fatigue.

### BACKGROUND OF THE INVENTION

1. Field of the Invention

The invention is related to a kneading massage structure; particularly to a light and thin mini kneading massage structure.

2. Description of the Prior Art

As for the structure of the conventional massage chair, please refer to the Taiwan bulletin No. 478359, the Massage Device of Massage Chair (Cited Reference). It mainly includes the following parts: a plate that has a top to form a rail level and a positioning block established at both ends with an shaft hole respectively; a screw bolt whose two ends pass through the shaft holes, and one end is connected to a power source so that the screw bolt rotates between the two positioning blocks; a sliding seat with a hollowed out seat that can slide on the rail level of the base plate with a hole horizontally running through, and the bolt hole can be screwed to the screw bolt with the holes at both sides; two massage wheels that respectively include a rotating shaft running through the hole of the sliding seat, a gearing wheel engaged with the screw bolt, and a contact roller running outside of the sliding seat, with one end of the rotating shaft connected with the gearing wheel and the other with the contact roller.

Although in the said cited reference the device has the function of massage. It is driven by an AC motor, which increases the total weight and bulk, and the massage by contact rollers will hardly make people comfortable. Improvement is necessary, as the user will feel painful on the back after the contact roller rolling on the back up and down for a long time.

Thus it can be seen that the said conventional device is not a perfect design with the defects and improvement is necessary.

In consideration of the defects of the said conventional massage chair, the inventor wants to improve the design, and finally develops the kneading massage structure after years of study and great concentration.

### SUMMARY OF THE INVENTION

The invention aims to provide a kneading massage structure driven by a small DC motor to move up and down the device with the massage block, driven by another DC motor, rotating from inner to outer or from outer to inner to achieve the effects of kneading and massage.

The second object of the invention is to provide a kneading massage structure small in bulk, light in weight, easy to install and low in cost.

It is another object of the invention to provide a kneading massage structure applied in movable massage cushions, massage beds, massage chairs, office chairs, automobile chairs, and leisure chairs.

The kneading massage structure with the said objects includes a base and a massage device. The inner wall of one side of the base is bound with a sliding rail in which a slide plate moves up and down on the sliding rail The inner of the base is bound with a screw bolt whose two ends are set in the pillow block for ball bearing, and one end is connected to the power output terminal of the first DC motor. The screw bolt is screwed with a slide block bound with a positioning block. The massage device contains a reduction gear disc with one end engaged with the power output terminal of the second DC motor and several rotating shafts extending outside to connect with the tapered massage block so that the massage block is driven by the motor to rotate from inner to outer or from outer to inner like kneading of fingers. The massage device is installed in the slide plate and the positioning plate. When it works, the first motor drives the screw bolt to rotate so that the slide block on it moves up and down accordingly, and further drives the massage device to position or to slide up and down, which relieves the user from fatigue with the back massage. A massage device shall be bound at the top of the base for the user to massage his neck in his own discretion.

### BRIEF DESCRIPTION OF THE DRAWINGS

The drawings disclose an illustrative embodiment of the present invention, which serves to exemplify the various advantages and objects hereof, and are as follows:

FIG. 1 is an exploded schematic view of the massage device of the kneading massage structure of this invention;

FIG. 2A is a front three-dimensional view of the massage device of the kneading massage structure of this invention

FIG. 2B is a back three-dimensional view of the massage device of the kneading massage structure of this invention

FIG. 3 is an exploded schematic view of the kneading massage structure of this invention;

FIG. 4 is a complex schematic view of the kneading massage structure of this invention;

FIG. 5 is an implementation schematic view of the kneading massage structure of this invention; and

FIG. 6 is an operation schematic view of the kneading massage structure of this invention.

### DETAILED DESCRIPTION OF THE PREFERRED EMBODIMENT

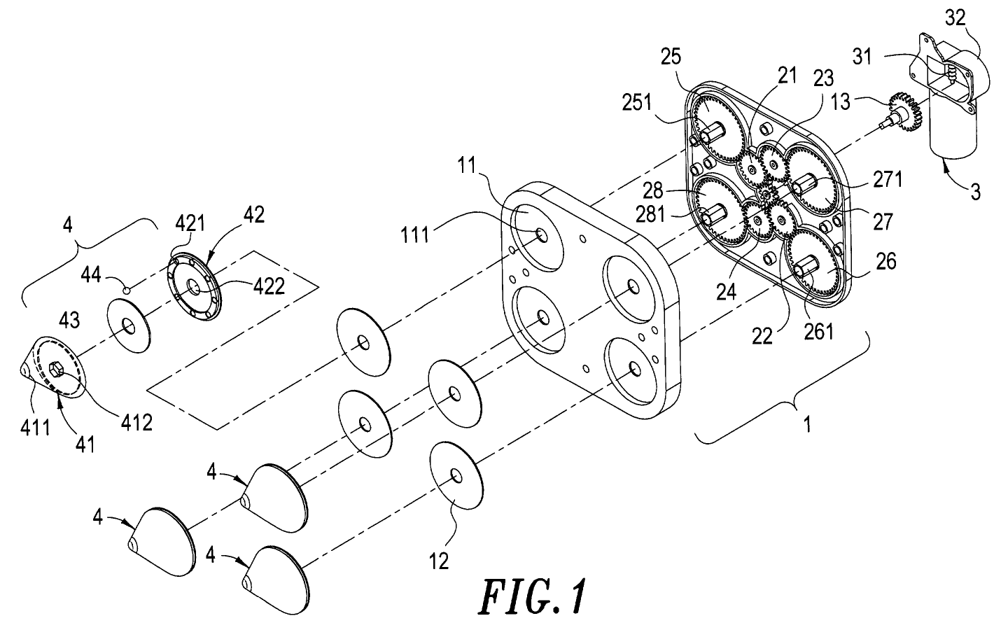

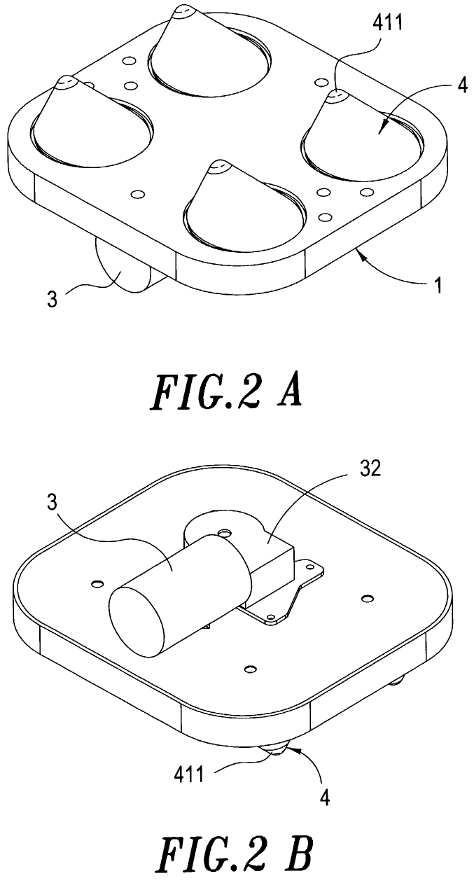

Please refer to FIG. 1, FIG. 2A, and FIG. 2B, which are schematic views of the massage device of the kneading massage structure of this invention mainly including:

A reduction gear disc 1 includes a drive gear wheel 20 and 8 driven gears 21˜28. Therein the drive gear wheel 20 is engaged with the first driven gear 21 and the second driven gear 22, the first driven gear 21 are engaged with the third driven gear 23 and the fifth driven gear 25, the second driven gear 22 are engaged with the fourth driven gear 24 and the sixth driven gear 26, the seventh driven gear 27 are engaged with the third driven gear 23, and the eighth driven gear 28 are engaged with the fourth driven gear 24. According to the size, the gears will be listed in a descending order: the driven gears from the fifth to the eighth 25˜28 are the biggest, then the driven gears from the first to the fourth 21˜24 are the following, and the drive gear wheel 20 is the smallest, which form a reduction gear set. The driven gears from fifth to the eighth 25˜28 extend power-take-off shafts 251, 261, 271, and 281 respectively. At the top of the reduction gear disc 1, there are 4 concaves 11 in which a hole 111 is located to exposure power-take-off shafts 251, 261, 271 and 281, which are covered by a metal pad 12 set in each concave 11. At the bottom of the reduction gear disc 1, there is a gearing wheel 13 closely connected to the drive gear wheel 20 within the reduction gear disc 1.

A second DC motor 3. A worm wheel 31 in a positioning base 32 is bound with the output shaft of the second DC motor 3. The positioning base 32 is connected to the bottom of the reduction gear disc 1 to cover the gearing wheel 13, making the worm gear 31 of the output shaft of the second DC motor to be engaged with the gearing wheel 13, then the power output from the second DC motor is sent to the reduction gear disc 1 through the gearing wheel 13 and increases the twisting force output from the power-take-off shafts 251, 261, 271 and 281 after being reduced by the reduction gear set1.

A massage block 4. It includes a body 41 and a bottom cover 42. The body 41 is tapered with the top connected to an active block 411 and the bottom is set with a hole 412. Around the bottom cover 42 there are several holes 421, each with a ball gearing 44 set in, and at the center part there is a hole 422. The bottom cover 42 is connected with the bottom of the body 41, which makes the hole 422 of the bottom cover corresponding to the hole 412 of the body. A metal pad 43 is set at the point of connection to make the ends of the ball 44 around the bottom cover 42 to contact with the metal pad 43. The exposure power-take-off shaft of the reduction gear disc is installed in the massage block so that the bottom cover 42 of the massage block 4 is set in the concave 11 at the top of the reduction gear disc 1 and another end of the ball 44 around the bottom contacts with the metal pad 12 in the concave 11. Except for favoring the rotation of the ball 44, the structure also relatively helps the rotation of the massage block 4 and avoids the massage block 4 and the reduction gear disc 1 from wearing when the ball 44 rotates.

When the second DC motor 3 runs, its power is transmitted to the reduction gear disc 1 via the worm gear 31 and gearing wheel 13, hereby the power-take-off shaft 251,261,271 and 281 outside the reduction gear disc 1 will drive the massage block 4 to rotate from inner to outer or from outer to inner, just as the user kneading with fingers.

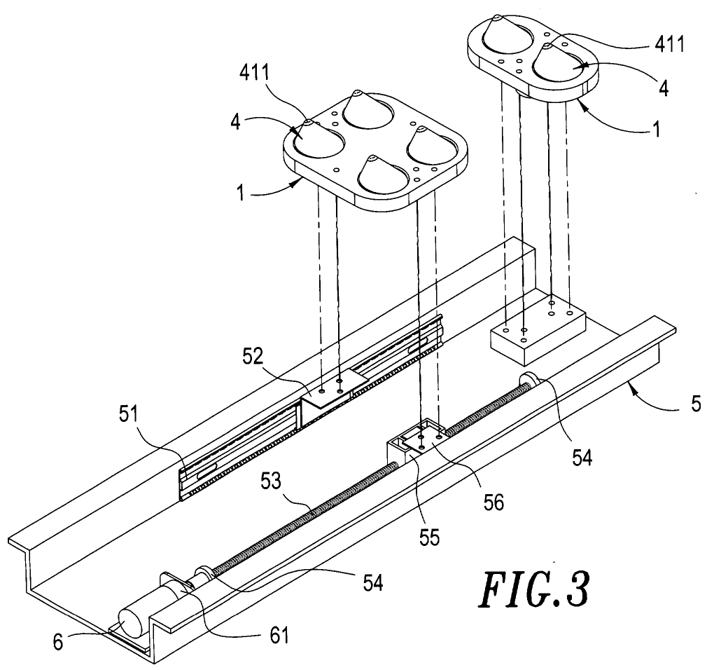

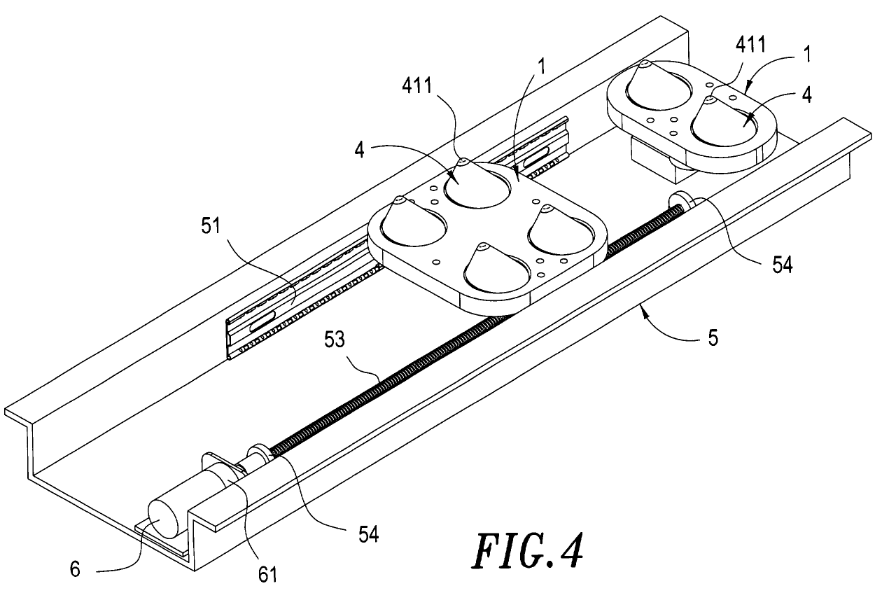

Please refer to FIGS. 3 and 4, the kneading-applied massage structure provided by this invention. It mainly contains a base 5, on the top of which 5 is bound a first massage device 1 designed for kneading the neck of the user to eliminate the aching pain. Besides, the said first massage device 1 may be installed or set on requirements; on the top and bottom of the said base 5 is bound a pillow block for ball bearing 54 each with a sliding rail bound on the inner wall of one side 51, and the said sliding rail is bound with a slide plate 52; the said base is also bound with a screw bolt 53, whose 53 two ends are positioned in the pillow blocks for ball bearing 54 on the top and bottom ends of the base, helping position the screw bolt 53 and facilitating its rotation. On the said screw bolt 53 is screwed with a slide block 55, on which 55 a positioning plate 56 is bound. The positioning plate 56 connects one end of the screw bolt 53 with the power output terminal of the first DC motor 6, whose 6 output shaft is connected to the reduction gear set 61, so that the output twisting force increases after the power output from the first DC motor 6 reduced by the reduction gear set 61; i.e. to lock the second massage device 1 on the slide plate 52 and in the positioning plate 56; when the first motor 6 runs, its output twisting force increases after its power reduced via reduction gear set 61, thereby driving the rotation of the screw bolt 53. Thus, the slide block 55 on the screw 63 will, depending on the corotation or reversion of the DC motor 6, move up and down or make single movement up or down and position, thereby driving the second massage device 1 to move. One end of the second massage device 1 is bound to the slide plate 52 on the sliding rail 51, which facilitates the sliding movement up and down.

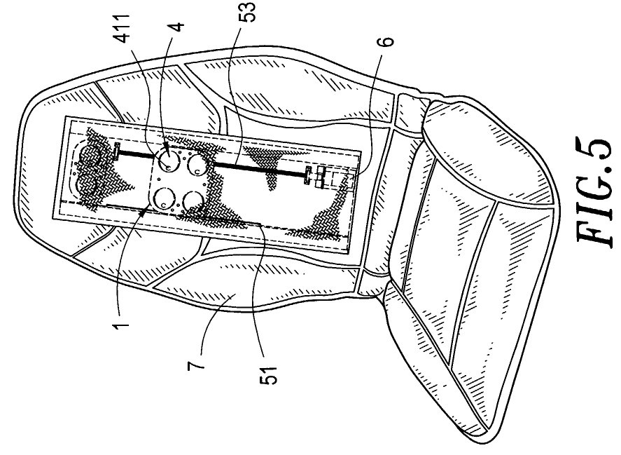

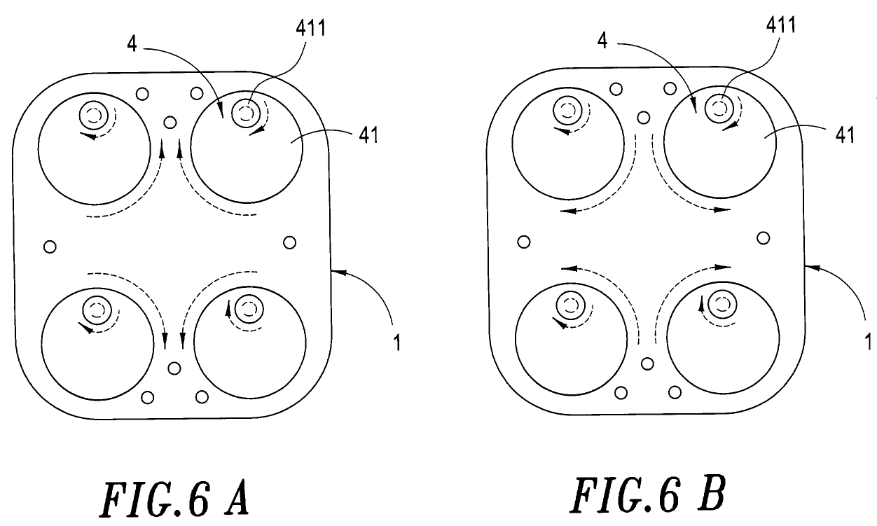

Please see FIGS. 5 and 6. It is a kneading applied massage structure provided by this invention. The said base 5 with massage device 1 can be installed in the massage chair, massage bed, car seat, leisure chair, office chair or massage cushion 7. Through controlling the circuit, users may control the corotation and reversion of the first and second motor 6,3 to enable them control the rotation of the massage block 4 on the massage device 1 from inner to outer or from outer to inner as well as the position where the massage device 1 moves up and down, thus the user will enjoy message just as someone is kneading on the back when he lies on the massage chair. In addition, an active block 411 is combined on the top of the massage block 4. The active block 411 will rotate with the rotation of the massage block 4, thus users won't feel uncomfortable on the back of during the massage in order to eliminate the aching pain and relieve fatigue.

When compared with the above-cited example with other typical technology, the kneading applied massage structure provided by this invention has the following advantages:

1. This invention apply DC motors of small bulk to directly drive the up-and-down movement of the massage device, and then drive the massage block on the massage device to rotate from inner to outer or from outer to inner through the other DC motor, thus, users will feel the rotation is just like kneading in order to relieve fatigue.

2. This invention may be applied in the massage bed, office chair, leisure chair, car seat and massage cushion or massage chair. It is small in bulk, light in weight, easy in assembly and low in cost.

3. The massage device of this invention can be used separately. Users may hold it with hand to massage the aching part in order to relieve the aching pain.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A structure for kneading applied massage at least including:
a base having two corresponding pillow blocks for ball bearing bound on a top side and a bottom side respectively;
a sliding rail bound on an inner wall of one side of the base with a slide plate thereon;
a screw bolt having two ends positioned in the pillow blocks of the base respectively with a slide block thereon, and a positioning plate being bound on the slide block;
a first motor, which output shaft is connected with a reduction gear set, and the output shaft of the said reduction gear set is closely fitted with one end of the screw bolt;
a massage device containing a reduction gear disc, wherein said reduction gear being engaged with a power output of a second motor and extending at least one power-take-off shaft for connecting to a rotatable block being on a tapered massage block; when the second motor runs, the output power will reduces by reducing the reduction gear disc and the twisting force will increase and output by the reducing power with the power-take-off shaft of the reduction gear disc, thereby driving the tapered massage block to rotate from inner to outer or from outer to inner;
wherein said massage device is bound in the slide plate and the positioning plate; when the first motor runs, said massage device will drive the screw bolt to rotate, so that the slide block on the screw bolt will move up and down with the rotation, and drive the massage device to move up and down, or separately move up and down at the fixed points; and thus the user may have said kneading applied massage up and down or at the fixed points on the back to effectively relieve fatigue.

2. The kneading applied massage structure according to claim 1, wherein said reduction gear disc having at least a concave, which is bound with a metal pad and set a gearing wheel on the bottom of the reduction gear disc; wherein the gearing wheel is closely engaged with a drive gear wheel of the reduction gear disc, and a worm wheel is bound on the power-take-off shaft; wherein the worm wheel is engaged with the gearing wheel so that the power output from the second motor can be sent to the reduction gear disc through worm wheel and gearing wheel for reduction and to increase the output twisting force.

3. The kneading applied massage structure according to claim 1 or 2, wherein the massage block includes a body having a rotatble block on top and a hole at the bottom; a bottom plate having a plurality of holes surrounding thereon and a hole in the center, in each of the hole is set a ball; wherein said bottom plate is connected to the bottom of said body for the holes positioned at the bottom correspond to the holes on the body; and
a metal pad positioned between said body and said bottom plate for contacting with said balls; while the massage block connects with said power-take-off shaft of said reduction gear, said bottom plate of said massage block is positioned in said concave of said reduction gear disk for enabling said balls surrounded with the bottom plate resisting against each other to facilitate the rotation of the balls as well as the rotation of the massage block and prevent the abrasion of the massage block and reduction gear disc caused by the balls during the rotation.

4. The kneading applied massage structure according to claim 1, wherein said base may be bound with an additional massage device used for kneading massage for the user to relieve the pain in the neck.
